(19) United States
(12) Patent Application Publication
(10) Pub. No.: US 2011/0142754 A1
(43) Pub. Date: Jun. 16, 2011

(54) ONE-OFF AND ADJUSTMENT METHOD OF HYDROGEN RELEASING FROM CHEMICAL HYDRIDE

(76) Inventors: Jie-Ren KU, Kaohsiung City (TW); Chan-Li HSUEH, Kaohsiung County (TW); Cheng-Yen CHEN, Yongkang City (TW); Ming-Shan JENG, Xizhi City (TW); Fang-hei TSAU, Kaohsiung City (TW)

(21) Appl. No.: 12/870,301

(22) Filed: Aug. 27, 2010

Related U.S. Application Data
(60) Provisional application No. 61/285,467, filed on Dec. 10, 2009.

(30) Foreign Application Priority Data
Jul. 6, 2010 (TW) 099122243
Aug. 3, 2010 (CN) 201010243281.5

(51) Int. Cl. C01B 3/06; C01B 3/08

(52) U.S. Cl. 423/657; 423/648.1; 977/773

(57) ABSTRACT

An one-off and adjustment method of hydrogen releasing from chemical hydride. The “one/off” of hydrogen release is controlled by the “contact/non-contact” procedures between the reactants. First, at least a hydride powder, a catalyst powder and a water-containing reactant are provided, and at least any two of three are mixed to form a mixture. Hydrogen gas is generated by adjusting a contact area between the mixture and the remaining one. The hydrogen-releasing reaction is terminated when a non-contacting state between the mixture and the remaining one occurs. Alternatively, an inhibitor or an inhibiting method could be used for suppressing or terminating the hydrogen-releasing reaction. The hydrogen-releasing rate could be controlled and adjusted by the extent of suppression.

This application claims the benefits of U.S. provisional application No. 61/285,467, filed Dec. 10, 2009, Taiwan application Serial No. 099122243, filed Jul. 6, 2010 and People's Republic of China application Serial No. 201010243281.5, filed Aug. 3, 2010, the subject matters of which are incorporated herein by reference.

### BACKGROUND

1. Field of the Invention

The disclosure relates in general to a one-off and adjustment method of hydrogen releasing from chemical hydride, and more particularly to a method for releasing hydrogen via “contact and non-contact” to switch the reaction “on and off”.

2. Description of the Related Art

Fuel cell is a device capable of converting chemical energy into electrical energy. The fuel cell can generate electrical energy continuously while fuel and oxidant are provided constantly. As to the hydrogen fuel cell, the fuel is hydrogen, and the oxidant is oxygen. The conventional hydrogen production system in a hydrogen fuel is usually designed to include several complicated units, such as the motors, the sensors and logic circuits, for controlling the hydrogen production system.

FIG. 1 illustrates a conventional active hydrogen production system. Sodium borohydride (NaBH₄) solution could be used as a hydrogen source in the hydrogen production system of FIG. 1. The conventional hydrogen production system is used for abstracting hydrogen from sodium borohydride solution so as to provide hydrogen for a fuel cell. As shown in FIG. 1, the hydrogen production system includes a pump 11, a fuel tank 12, a catalyst bed 13, a spent fuel storage tank 15, a gas liquid separator 16, a pressure sensor 17 and a controller 18. The pump 11 transports the liquid fuel—sodium borohydride solution in the fuel tank 12 to the catalyst bed 13. A hydrogen releasing reaction reacted from sodium borohydride and water is catalyzed by the catalyst bed. The chemical equation (1) is:

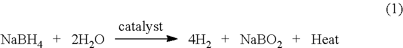

After hydrogen is released, the product of the hydrolysis reaction of sodium borohydride, namely sodium perborate solution, is extracted from the catalyst bed by separating from hydrogen due to the difference of specific gravities, and the extracted sodium perborate solution is then transported to the spent fuel storage tank 15. Also, hydrogen is discharged through an outlet 161 on the top of the gas liquid separator 16 for use. The pressure sensor 17 positioned on the upper part of the gas liquid separator 16 is able to monitor the pressure of hydrogen instantly. The pressure sensor 17 is also electrically connected to the controller 18.

When the conventional hydrogen production system starts to operate, the controller 18 controls the pump 11 according to the pressure of hydrogen detected by the pressure sensor 17, for further controlling the hydrogen production. For example, when the pressure sensor 17 detects that the pressure of hydrogen is insufficient, the pump 11 transports sodium borohydride solution in the fuel tank 12. Accordingly, the hydrogen production rate and pressure of hydrogen could be adequately adjusted and controlled.

FIG. 2 illustrates a conventional passive hydrogen production system. Hydrogen generated from the passive hydrogen production system of FIG. 2 is based on the pressure variation for assisting sodium borohydride (NaBH4) hydrolysis by hydrochloric acid (HCl). When NaBH4 is neutralized by using HCl, the reaction for producing hydrogen speeds up. When the pressure caused by sufficient amounts of hydrogen is increased to a certain value therefore stopping the contact of NaBH4 and HCl, the reaction of generating hydrogen stops. As shown in FIG. 2, two chambers, one filled with solid NaBH4 (so called as the NaBH4 chamber 24), the other with a solution of HCl in water (so called as the HCl chamber 25), are connected by a narrow tube. A pressure slightly higher than the pressure set by the first valve (i.e. regulation valve) 231 was reached by flowing hydrogen in the system, meanwhile the first valve 231 is opened and no contact between NaBH4 and HCl. Opening the third valve 233 (i.e. outlet valve) causes a pressure decrease. When the pressure becomes lower than the set value, the first valve 231 closes. Further pressure decrease (the third valve 233 is still opened while the first valve 231 is closed) forces the acid solution HCl to pass into the NaBH4 chamber 24 where it comes in contact with NaBH4, producing hydrogen since the pressure in the NaBH4 chamber 24 is lower than the pressure in the HCl chamber 25. The produced hydrogen is exhausted through the third valve 233. When the third valve 233 (i.e. outlet valve) is closed, the produced hydrogen over-pressurizes the NaBH4 chamber 24 (i.e. the pressure in the NaBH4 chamber 24 higher than the pressure in the HCl chamber 25), making the acid solution HCl to go back and stopping the reaction. Opening or closing the third valve 233 therefore allows the reaction to start or stop. The second valve 232 is a safety valve. If the pressure inside the system increases to reach the set pressure for the second valve 232, the excess of hydrogen produced will be eliminate avoiding dangerous overpressure.

However, those conventional hydrogen production systems as described above all have very complicated mechanical designs with bulky dimensions and weights, which is expansive and not easy to carry for daily use.

### SUMMARY

The disclosure relates to a one-off and adjustment method of hydrogen releasing from chemical hydride. Hydrogen is generated via “contact and non-contact” between the reactants so as to switch the reaction “on and off”.

According to the first aspect of the present disclosure, a method of hydrogen releasing from chemical hydride is provided. First, at least a hydride powder, a catalyst powder and a water-containing reactant are provided. Any two of the hydride powder, the catalyst powder and the water-containing reactant are then mixed to form a mixture. Next, a contact area between the mixture and the remaining one of the hydride powder, the catalyst powder and the water-containing reactant is adjusted for controlling a hydrogen-releasing reaction. When the mixture and the remaining one is in a contact condition, the hydride powder reacts with the water-containing reactant to bring about the hydrogen-releasing reaction, and the catalyst powder catalyzes the hydrogen-releasing reaction.

The disclosure will become apparent from the following detailed description of the preferred but non-limiting embodiments. The following description is made with reference to the accompanying drawings.

### BRIEF DESCRIPTION OF THE DRAWINGS

FIG. 1 illustrates a conventional active hydrogen production system.

FIG. 2 illustrates a conventional passive hydrogen production system.

FIG. 3A and FIG. 3B simply illustrate an experimental module for switching the hydrogen generation reaction “on and off” via “contact and non-contact” between the reactants according to the embodiment of the disclosure.

FIG. 4 shows the result of an experiment for turning the hydrogen-releasing reaction “on and off” at one stage.

FIG. 5 shows the result of another experiment for turning the hydrogen-releasing reaction “on and off” at two stages.

FIG. 6 simply illustrates an experimental module for switching the hydrogen generation reaction “on and off” via “contact and inhibition” according to another embodiment of the disclosure.

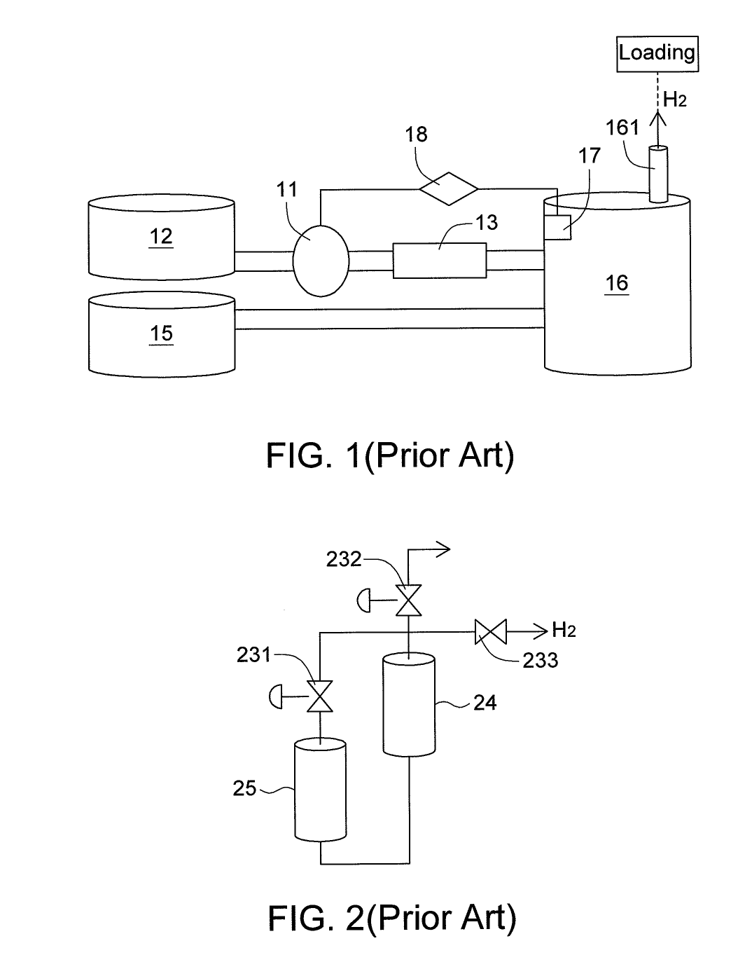

### DETAILED DESCRIPTION

In the embodiments of the present disclosure, a one-off and adjustment method of hydrogen releasing from chemical hydride is provided. Hydrogen is generated via “contact and non-contact” between the reactants so as to switch the reaction “on and off”. Alternatively, an inhibitor or an inhibiting method could be used for suppressing or terminating the hydrogen-releasing reaction.

The embodiments are provided to demonstrate the one-off and adjustment method of hydrogen releasing from chemical hydride. Also, the embodiments are described with reference to the related experiments. However, the compounds, materials and steps for providing hydrogen illustrated in the embodiments are not intended to limit the invention. The modifications and variations can be made without departing from the spirit of the disclosure to meet the requirements of the practical applications.

In the embodiments, the hydrogen releasing reaction is turned “on and off” via “contact and non-contact” between the reactants. Hydrogen is generated by adjusting a contact area between the reactants. The larger the contact area, the faster the hydrogen releasing rate. When the reactants are in a contact condition, the hydride powder reacts with water (from a water-containing reactant) to bring about the hydrogen-releasing reaction, and the catalyst powder catalyzes the hydrogen-releasing reaction. When the reactants are in a non-contact condition, the hydrogen-releasing reaction is terminated and hydrogen generation stops.

The reactants include at least a hydride powder, a catalyst powder and a water-containing reactant. Any two of the hydride powder, the catalyst powder and the water-containing reactant could be selected to contact or be non-contact with the remaining one of the reactants. The hydride powder and the catalyst powder could be referred as the solid hydrogen fuel. In an embodiment, any two of the hydride powder, the catalyst powder and the water-containing reactant could form a mixture, and a hydrogen releasing reaction is controlled via contact between the mixture and the remaining reactant for generating hydrogen. In a contact condition, the hydride powder reacts with the water-containing reactant to bring about the hydrogen-releasing reaction, which is catalyzed by the catalyst powder. In an embodiment, a contact area between the mixture and the remaining reactant is substantially proportional to the hydrogen generation rate. For example, when the contact area between the mixture and the remaining reactant is larger than half area of a complete contact area, the hydrogen generation rate is larger than half of theoretical maximum in the design.

In an embodiment, the hydride powder and the catalyst powder could be individually ground and then mixed well as a mixture. Alternatively, the hydride powder and the catalyst powder could be ground and mixed simultaneously. The mixture containing well-mixed hydride powder and catalyst powder are pressed to form a solid block. The “grinding” or “individually grinding followed by mixing” process could be performed by various types of crushers, millers, mills and grinding machines. When the solid block contacts with the water-containing reactant, the hydrogen releasing reaction is activated (i.e. “on”) to generate hydrogen. When a contact area actually between the mixture and the remaining reactant is larger than ½ of a maximum contact area, the hydrogen generation rate is larger than ½ of designed maximum rate. When the solid block and the water-containing reactant are in a non-contact condition, the hydrogen releasing reaction is terminated (i.e. “off”) to stop hydrogen generation. The water-containing reactant could be the water gel, and subjected to pre-treatment before use. For example, before contacting the water gel with the solid block, water is added into a bottle having the water gel.

In an alternative embodiment, the hydride powder and the water-containing reactant could be individually ground and then mixed well as a mixture. The mixture containing well-mixed hydride powder and the water-containing reactant are pressed to form a solid block. Similarly, when the solid block contacts with the catalyst powder, the hydrogen releasing reaction is activated (i.e. “on”) to generate hydrogen. When the solid block and the catalyst powder are in a non-contact condition, the hydrogen releasing reaction is terminated (i.e. “off”) to stop hydrogen generation. Since the price of the catalyst powder is high, the catalyst powder in this method can be recycled and reused. It not only saves the cost, but also protects the environment from wasting the resource. It also facilitates recycling of the catalyst powder.

In an embodiment, the hydride powder could be boron hydride, nitrogen hydride, carbon hydride, metal hydride, nitrogen borohydride, carbon borohydride, nitrogen carbon hydride, metal borohydride, metal nitrogen hydride, metal carbon hydride, metal nitrogen borohydride, metal carbon borohydride, metal nitrogen carbon hydride, nitrogen carbon borohydride, metal nitrogen carbon borohydride, or a combination thereof. Examples of the hydride powder include sodium borohydride (NaBH₄), lithium aluminum hydride (LiAlH₄), sodium aluminum hydride (NaAlH4), magnesium aluminum hydride (Mg(AlH₄)₂), calcium aluminum hydride (Ca(AlH₄)₂), lithium borohydride (LiBH₄), potassium borohydride (KBH₄), beryllium borohydride (Be(BH₄)₂), magnesium borohydride (Mg(BH₄)₂), calcium borohydride (Ca(BH₄)₂), lithium hydride (LiH), sodium hydride (NaH), magnesium hydride (MgH₂), or calcium hydride (CaH₂).

In another embodiment, the hydride powder is a hydride or a chemical compound represented by the formula BxNyHz. Examples of compound represented by the formula BxNyHz include ammonia borane (H3BNH3), diborane, H2B(NH3)2BH4, poly(amine-borane), borazine (B3N3H6), borane-tetrahydrofuran complex, and diborane and the likes.

In an embodiment, the catalyst powder may comprise solid acid, or metal salt including at least one of ruthenium, cobalt, nickel, copper and iron, or metal nano-particles/micro-particles including at least one of ruthenium, cobalt, nickel, copper and iron, or a plurality of catalyst metal carriers covered by metal irons/metal atomics/metal nano-particles/meta micro-particles including at least one of ruthenium, cobalt, nickel, copper and iron.

In an application, a flexible polymer matrix may be mixed with the hydride powder and the catalyst powder (i.e. the solid hydrogen fuel) to provide the flexibility and the deformation of the solid hydrogen fuel. The flexible polymer matrix could be a hydrophobic polymer elastomer such as silicone, rubber, and silicon rubber.

In an embodiment, the water-containing reactant could be the liquid state or the solid state. Examples of the water-containing reactant in the liquid state include water, alcohols, alcoholic solutions, aqueous solutions of salts, aqueous solutions of acids, or a combination thereof. The water-containing reactant in the solid state could be a water-absorbing polymer, such as polyacrylate, polyvinyl alcohol (PVA), ethylene vinyl acetate (EVA), polyurethane (PU), polyoxyethylene (polyethylene oxide), starch graft copolymer, or rubber blend.

It is noted that the compounds of the hydride powder, the catalyst powder and the water-containing reactant (and the flexible polymer matrix) are not limited to any of aforementioned compounds. Also, the hydride powder, the catalyst powder and the water-containing reactant could be the ground or un-ground powders, dispersed or pressed as the tablets. For example, any two of three reactants are mixed pressed as a tablet, while the remaining reactant is pressed as another tablet. Alternatively, any two of three reactants could be mixed pressed as a tablet, while the remaining reactant is dispersed evenly. It is understood that the states of three reactants could be optionally selected, depending on the requirements of the practical application.

Several experiments are conducted in the embodiment of the present disclosure for observing the effects of “contact and non-contact” between the reactants on the hydrogen generation (i.e. “on and off”). Experiments and the results thereof are disclosed below.

### Relative Experiment

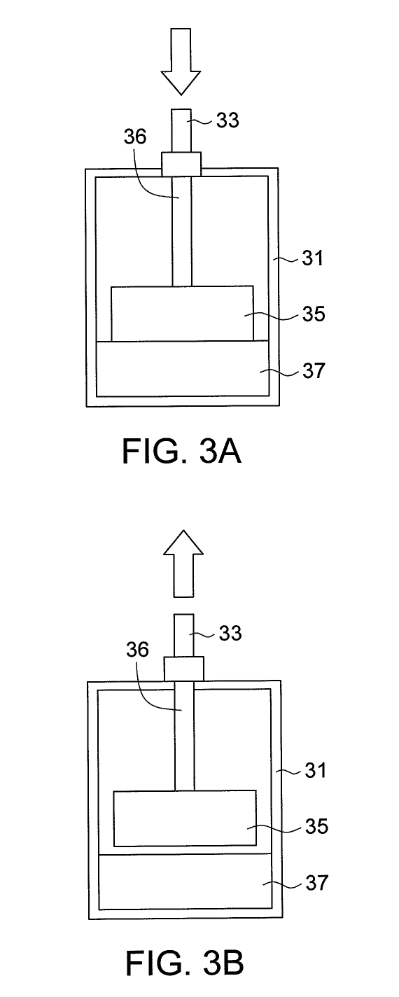

FIG. 3A and FIG. 3B simply illustrate an experimental module for switching the hydrogen generation reaction “on and off” via “contact and non-contact” between the reactants according to the embodiment of the disclosure. As shown in FIG. 3A and FIG. 3B, the “on and off” switch of the experimental module is achieved by the pumping apparatus. A sealed can 31 is provided, and a gas pipe 33 is attached to the sealed can 31 for communicating the sealed can 31 and a mass flow meter. A flexible solid hydrogen fuel 35 is positioned at one end of a moveable rod 36, which is able to do the up-and-down motion within the sealed can 31. A solid water 37 is placed in the sealed can 31.

A method for controlling the reaction “on and off” via “contact and non-contact” between the reactants is described below. First, the moveable rod 36 is push downward. When the flexible solid hydrogen fuel 35 contacts the solid water 37 (i.e. the switch is “on”), the hydrogen-releasing reaction is activated and hydrogen is generated, as shown in FIG. 3A. After the hydrogen-releasing rate is increased, the flexible solid hydrogen fuel 35 is separated from the solid water 37 by pulling the moveable rod 36 upward. By turning the switch is “off” as shown in FIG. 3B, the hydrogen-releasing reaction is terminated and the hydrogen-releasing rate is decreased gradually.

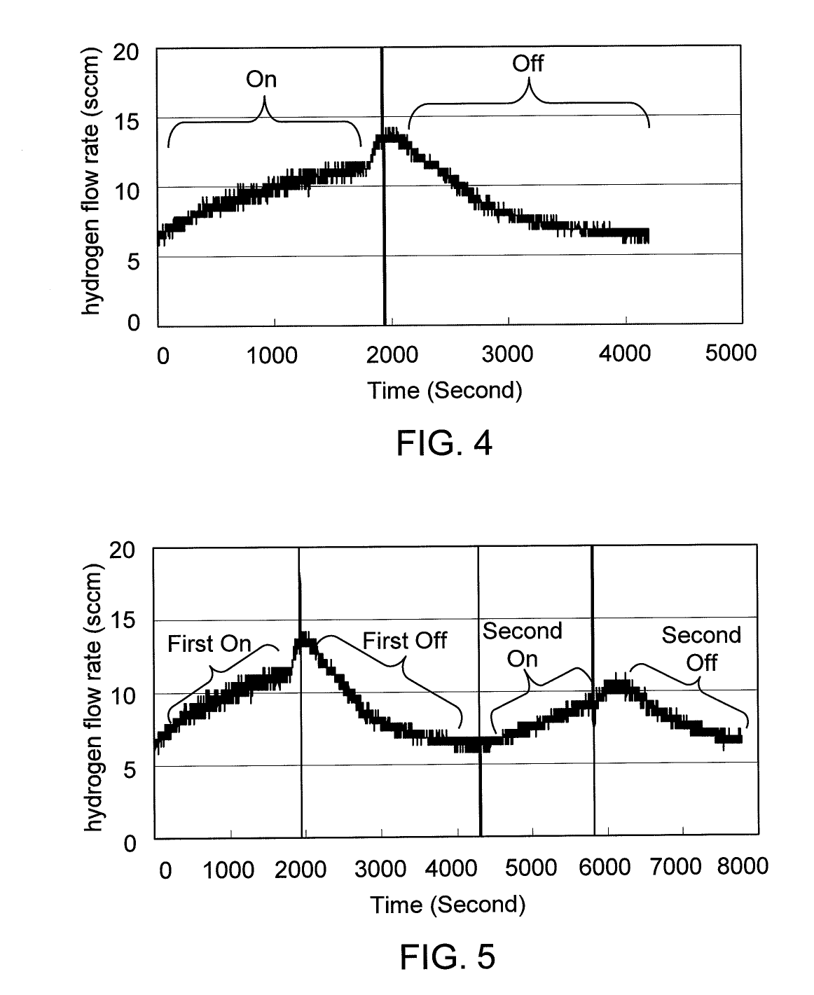

1 g of NaBH4 (the hydride powder), 0.3 g of cobalt ion catalyst (Co²⁺/IR-120, the catalyst powder) and 0.8 g of silicone rubber (i.e. molding agent) are used in an experiment. The experimental results are described below. When the moveable rod 36 is push downward to contact the solid hydrogen fuel 35 with the solid water 37, the switch is “on”. In the “on” state, the hydrogen flow rate is increased to about 13 sccm (standard cubic centimeters per minute) after 2000 seconds. Afterwards, the moveable rod 36 is pulled upward to turn the switch “off”, and the hydrogen flow rate is decreased to about 6 sccm after 1000˜1200 seconds. Since a small amount of water residue resting on the surface of the solid hydrogen fuel 35 would still cause the hydrogen-releasing reaction, the actual hydrogen flow rate would be decreased to about 1-2 sccm. Thus, the switch could be regarded as the “complete off” state although 6 sccm of the hydrogen flow rate is measured. FIG. 4 shows the result of an experiment for turning the hydrogen-releasing reaction “on and off” at one stage.

Another experiment is further conducted for observing whether a repeatability condition of “on and off” is developed. FIG. 5 shows the result of another experiment for turning the hydrogen-releasing reaction “on and off” at two stages. The moveable rod 36 is push downward again to contact the solid hydrogen fuel 35 with the solid water 37 at the 4200^{th} second. When the switch is “on” again, the hydrogen flow rate is gradually increased. At the 5800^{th} second, the moveable rod 36 is pulled upward again to turn the switch “off”, and the hydrogen flow rate is decreased to about 6 sccm at the 7800^{th} second. The experiment results have indicated that the pumping apparatus designed as shown in FIG. 3A and FIG. 3B does have the “on and off” effect on the hydrogen-releasing reaction.

According to the experiment results, it is indicated that the hydrogen releasing reaction can be effectively turned “on and off” via conditions of “contact and non-contact” between the reactants. Also, when the “contact and non-contact” steps are repeatedly performed, the “on and off” of the hydrogen releasing reaction can still be achieved.

The hydrogen-releasing reaction is not only terminated via the “non-contact” condition. An inhibitor or an inhibiting method, alternatively, could be adopted for suppressing or terminating the hydrogen-releasing reaction, and a hydrogen-releasing rate of the hydrogen-releasing reaction could be controlled and adjusted by the concentration of the inhibitor. In an embodiment, three reactants, including the hydride powder, the catalyst powder (solid hydrogen fuel) and the water-containing reactant, are mixed and shaped into an integrated form, an inhibitor or an inhibiting method might be injected for suppressing or terminating the hydrogen-releasing reaction, and a hydrogen-releasing rate of the hydrogen-releasing reaction is controlled and adjusted by an extent of suppression.

In an embodiment, the inhibitor could be an alkaline liquid, Isopropyl alcohol (IPA), the material able to react with water and forming an oxide, the material strongly absorbing or removing water, or the material able to isolate the hydride powder from water.

Examples of the inhibitor materials able to react with water and forming an oxide include, but not limited to, iron powder, aluminum powder, magnesium powder, calcium powder, calcium hydroxide, calcium oxide, and nano-particles thereof.

Also, the inhibitor could be sulfuric acid or sodium acetate, capable of strongly absorbing or removing water.

Also, the inhibitor could be a surfactant able to isolate water from the hydride powder and the catalyst powder.

Besides the inhibitor, an inhibiting method could be adopted for suppressing or terminating the hydrogen-releasing reaction. The inhibiting method could be any method capable of removing water, such as a heating method. In an embodiment, the heating method is performed by a high heating temperature furnace for removing water, and the heating temperature is in a rage of about 40° C.˜400° C., depending on the practical application. Moreover, the heating method could be conducted by using the heat released from an exothermic reaction of the inhibitor and water, and examples of the inhibitor include iron powder, aluminum powder, magnesium powder, calcium powder, calcium hydroxide, calcium oxide, and nano-particles thereof.

An experiment is conducted by using calcium oxide as the inhibitor for suppressing or terminating the hydrogen-releasing reaction. The procedures and experimental results are described below.

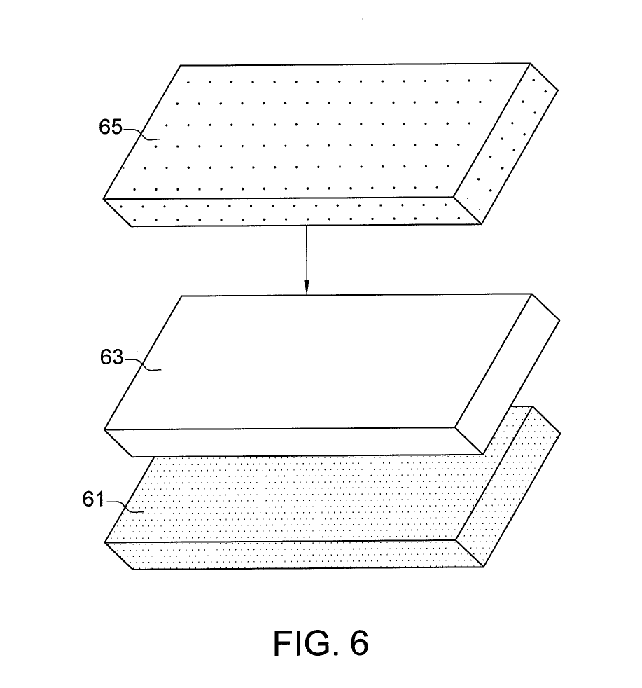

FIG. 6 simply illustrates an experimental module for switching the hydrogen generation reaction “on and off” via “contact and inhibition” according to another embodiment of the disclosure. In FIG. 6, a mixture 61, containing the hydride powder, the catalyst powder (solid hydrogen fuel) and the water-containing reactant, is releasing hydrogen. 2 g of calcium oxide in a form of tablet 65 is added into 1.5 ml of water 63, and the chemical reaction is exothermic. Water in the system, including water in the water-containing reactant, is evaporated by the heat released from the exothermic reaction, so as to suppress or terminate the hydrogen-releasing reaction. In the investigation of the repeatability of the experiment, five experiments are repeatedly conducted, and four experimental results have effectively show that the hydrogen-releasing reaction is suppressed or terminated for at least 30 minutes. One experimental result shows that the hydrogen-releasing reaction is suppressed or terminated for only 19 minutes, and it is hypothesized that the inadequate contact between the calcium oxide tablet 65 and water 63 causes the defective result.

According to the aforementioned disclosure, the one-off and adjustment method of hydrogen releasing from chemical hydride is performed by the “contact and non-contact” procedures for switching the reaction “on and off” effectively. Hydrogen is generated by adjusting a contact area between the reactants. The contact area is positively proportional to the hydrogen releasing rate. When a contact area actually between the mixture and the remaining reactant is larger than ½ of a maximum contact area, the hydrogen generation rate is larger than ½ of designed maximum rate. Alternatively, an inhibitor or an inhibiting method could be adopted for suppressing or terminating the hydrogen-releasing reaction, and a hydrogen-releasing rate of the hydrogen-releasing reaction could be controlled and adjusted by the extent of the suppression. According to the embodiment, the hydrogen releasing reaction and hydrogen generation rate are effectively controlled by an easy and simple method. Without the complicate and bulky mechanism, the small volume of the disclosed system is easier for the user to carry, and the production cost is greatly decreased. the methods of the embodiment have several advantages. Also, it is easier to match the mechanical design of the system and product, which simplifies the design of hydrogen production system. Furthermore, solid hydrogen fuel releases hydrogen completely, more effectively and rapidly. Above advantages increase users' willingness to use the product and widen the application field of the product.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of hydrogen releasing from chemical hydride, comprising:
providing at least a hydride powder, a catalyst powder and a water-containing reactant;
mixing any two of the hydride powder, the catalyst powder and the water-containing reactant to form a mixture;
adjusting a contact area between the mixture and the remaining one of the hydride powder, the catalyst powder and the water-containing reactant for controlling a hydrogen-releasing reaction, wherein the mixture and the remaining one is in a contact condition, the hydride powder reacts with the water-containing reactant to bring about the hydrogen-releasing reaction, and the catalyst powder catalyzes the hydrogen-releasing reaction.

2. The method according to claim 1, wherein the hydrogen-releasing reaction is terminated while a non-contacting state between the mixture and the remaining one occurs.

3. The method according to claim 1, wherein the water-containing reactant is one of water, alcohols, alcoholic solutions, aqueous solutions of salts, aqueous solutions of acids or a combination thereof.

4. The method according to claim 1, wherein the water-containing reactant is solid water.

5. The method according to claim 4, wherein said solid water is a water-absorbing polymer, comprising polyacrylate, polyvinyl alcohol (PVA), ethylene vinyl acetate (EVA), polyurethane (PU), polyoxyethylene (polyethylene oxide), starch graft copolymer, or rubber blend.

6. The method according to claim 4, wherein after providing the hydride powder, the catalyst powder and the water-containing reactant, the method further comprises a step of individually grinding the hydride powder and the water-containing reactant, and then mixing both to form the mixture, and then forming the mixture into a solid press-formed block, followed by contacting the solid press-formed block with the catalyst powder to catalyze the hydrogen-releasing reaction.

7. The method according to claim 4, wherein after providing the hydride powder, the catalyst powder and the water-containing reactant, the method further comprises a step of individually grinding the hydride powder and the catalyst powder, and then mixing both to form the mixture, and then forming the mixture into a solid press-formed block, followed by contacting the solid press-formed block with the water-containing reactant to bring out the hydrogen-releasing reaction.

8. The method according to claim 1, wherein the hydride powder, the catalyst powder and the water-containing reactant are mixed and shaped into an integrated form, and an inhibitor or an inhibiting method is adopted for suppressing or terminating the hydrogen-releasing reaction, and a hydrogen-releasing rate of the hydrogen-releasing reaction is controlled and adjusted by an extent of suppression.

9. The method according to claim 8, wherein the inhibitor is an alkaline liquid, Isopropyl alcohol (IPA), a material able to react with water and forming an oxide, a material strongly absorbing or removing water, or a material able to isolate the hydride powder from water, while the inhibiting method is a method capable of removing water.

10. The method according to claim 9, wherein the inhibitor is iron powder, aluminum powder, magnesium powder, calcium powder, calcium hydroxide, calcium oxide, or nano-particles thereof, for reacting with water to form the oxide.

11. The method according to claim 9, wherein the inhibitor is sulfuric acid or sodium acetate, capable of strongly absorbing or removing water.

12. The method according to claim 9, wherein the inhibiting method is a heating method for removing water.

13. The method according to claim 9, wherein the heating method is performed by a high heating temperature furnace.

14. The method according to claim 12, wherein the heating method is conducted by using the heat released from an exothermic reaction of the inhibitor and water, and the inhibitor is iron powder, aluminum powder, magnesium powder, calcium powder, calcium hydroxide, calcium oxide, or nano-particles thereof.

15. The method according to claim 12, wherein a heating temperature is in a rage of about 40° C.˜400° C.

16. The method according to claim 9, wherein the inhibitor is a surfactant able to isolate water from the hydride powder and the catalyst powder.

17. The method according to claim 1, wherein the hydride powder is selected from the group consisting of boron hydride, nitrogen hydride, carbon hydride, metal hydride, nitrogen borohydride, carbon borohydride, nitrogen carbon hydride, metal borohydride, metal nitrogen hydride, metal carbon hydride, metal nitrogen borohydride, metal carbon borohydride, metal nitrogen carbon hydride, nitrogen carbon borohydride, metal nitrogen carbon borohydride, and a combination thereof.
